(19) United States
(12) Patent Application Publication
(10) Pub. No.: US 2006/0265294 A1
(43) Pub. Date: Nov. 23, 2006

(54) System and method for facilitating tasks involving travel between locations

(76) Inventor: Robert F. de Sylva, Santa Monica, CA (US)

Correspondence Address: Robert de Sylva, #D, 161 Ocean Park Blvd., Santa Monica, CA, 90405, US

(21) Appl. No.: 11/438,935

(22) Filed: May 23, 2006

Related U.S. Application Data
(60) Provisional application No. 60/683,744, filed on May 23, 2005.

(51) Int. Cl. G05B 19/00; G06F 7/00; G08C 19/00

(52) U.S. Cl. 705/28; 340/5.92; 700/225

(57) ABSTRACT

A system for increasing the efficiency of tasks involving travel between locations. In an illustrative embodiment, the system facilitates acquiring one or more desired products and/or services by a user via an inventory and/or location search. The system includes a first mechanism for providing a query containing information pertaining to the one or more desired products and/or services. A second mechanism performs an inventory search of multiple businesses based on the query and provides search results to the first mechanism in response thereto. In the specific embodiment, the search results contain approximately real-time inventory information and Global Positioning System (GPS) location information associated with the query. The query includes price-preference information pertaining to one or more desired prices or price ranges associated with the one or more desired products and/or services.

### CLAIM OF PRIORITY

This invention This invention claims priority from U.S. Provisional Patent Application Ser. No. 60/683,744, entitled SYSTEM AND METHOD FOR FACILITATING TASKS INVOLVING TRAVEL BETWEEN LOCATIONS, filed on May 23, 2005, which is hereby incorporated by reference as if set forth in full in this specification.

### BACKGROUND OF THE INVENTION

1. Field of Invention

This invention relates to networks. Specifically, the present invention relates to systems and methods that employ one or more networks to increase the efficiency of tasks involving travel between different locations.

2. Description of the Related Art

Systems for facilitating tasks involving travel between locations are employed in various demanding applications including computer-controlled highways, Internet-searchable catalogs and phonebooks, Global Positioning System (GPS) navigation systems, and delivery systems. These so-called efficiency systems aim to provide improvements over existing alternative systems.

Efficiency systems are particularly important in product/service-acquisition applications, where inefficient systems may inhibit commerce and may increase traffic congestion, green house gas emissions, fuel consumption and prices, automobile accidents, automobile-maintenance costs, road-maintenance costs, and so on.

Conventionally, to obtain a desired product or service, a user may search a local phone book and then call various outlets to determine product or service availability. However, outlets may receive multiple calls, and telephone hold times may be prohibitively lengthy.

Alternatively, a user may drive to various outlets to physically search for a desired product and/or service. As a user drives between outlets, the user contributes to traffic congestion. Upon arriving at an outlet, such as a store, a user must often then roam the store isles to locate a particular product.

Alternatively, the user may ask store staff for assistance in locating a desired product. Unfortunately, staff may be occupied with other customers or otherwise unavailable. Customers that ask store staff for assistance in locating products and/or services place additional demands on staff who could be performing other productive tasks.

Efficiency systems, such as Internet search engines, are often employed to search and locate businesses offering certain desired products and/or services. A typical Internet search may yield merchant websites. The merchant websites may contain additional information pertaining to inventory in local merchant outlets. This inventory information may assist customers in locating and obtaining desired products and/or services. Alternatively, certain websites allow users to search the websites for desired products and/or services, which may be purchased electronically. The products and/or services are then provided to the customer by a delivery service.

Customers may save time by employing efficiency systems, such as conventional search engines or websites, instead of physically visiting merchant outlets. However, the time saved is often offset by lengthy merchandise delivery times.

Hence, a need remains in the art for a system and method for improving the efficiency by which desired products and/or services are obtained by customers. There exists a further need for a system for improving traffic flow, reducing merchant workload, and/or saving the user time.

### SUMMARY OF THE INVENTION

The need in the art is addressed by the system for increasing the efficiency of tasks involving travel between locations of the present invention. In an illustrative embodiment, the system facilitates acquiring one or more desired products and/or services by a user via an inventory and/or location search. In this embodiment, the system includes a first mechanism for providing a query containing information pertaining to one or more desired products and/or services. A second mechanism performs an inventory search of multiple business locations based on the query and provides search results to the first mechanism in response thereto. The search results contain Global Positioning System (GPS) coordinate information pertaining to the one or more desired products and/or services.

In the specific embodiment, the search results contain approximately real-time inventory and location information associated with the query. In this embodiment, the query includes price-preference information pertaining to one or more desired prices or price ranges associated with the one or more desired products and/or services.

The novel design of one embodiment of the present invention is facilitated by the second mechanism, which may provide inventory information, including price and location information, pertaining to one or more desired products and/or services to a user of a mobile computing device, such as a Personal Digital Assistant (PDA), pocket computer, or wireless phone. The system may be employed, for example, to find the least expensive gas station along a given travel route or to find the optimal route between product/service outlets. Such a system may facilitate completing a desired shopping list in minimum time for a minimum price. An accompanying routing system facilitates selecting an optimal travel route between the user's location and one or more additional locations, which may correspond to the locations of outlets where one or more desired products and/or services are available. In one operational mode, the system may alert the user when the user is passing an outlet with a desired product or service available.

Use of embodiments of the present invention may yield various potentially significant, beneficial, and often unexpected or otherwise unobvious results. For example, the effects of competitive forces on prices may improve as usage of such embodiments increases. Merchants providing lower prices will more readily attract cost-conscious customers that are employing systems constructed according to embodiments of the present invention. For example, fuel prices may decrease as users more readily and efficiently locate the most cost-effective gas stations along particular routes. The particular routes may be the most efficient routes between outlets in terms of travel time, safety, or other priorities. The efficiencies resulting from use of the routing system compliment efficiencies resulting from expedited product/service-locating capabilities afforded by embodiments of the present invention.

Conventionally, users may randomly drive between outlets in search of various products/services. When a product/service is not found at one outlet, the customer often proceeds to drive to another outlet. At each particular outlet, the customer may have difficulty locating the product/service even if the product/service is available at the outlet. These inefficiencies are directly addressed by certain embodiments of the present invention, which can automatically pinpoint desired product/service locations within particular outlets.

The routing system component of certain embodiments of the present invention may improve traffic flow as fewer people spend excess time driving between outlets in search of desired products and/or services. Furthermore, the routing system component may consider various types of traffic information, including traffic congestion patterns, traffic-light timing patterns, traffic accident patterns, and emergency vehicle routes. Consequently, users may be routed around congestion; along routes that avoid routes of emergency vehicles; around dangerous intersections, and so on. Accordingly, as usage of such embodiments increases, traffic congestion, traffic accidents, and overall road usage may decrease. The selection of safer travel routes by users of embodiments of the present invention may yield fewer accidents, which may further reduce traffic congestion.

As traffic along routes traveled by emergency vehicles decreases, emergency-service personnel may more quickly and safely reach their destinations. Even without a decrease in congestion along emergency routes caused by user avoidance of emergency vehicle routes, use of embodiments of the present invention by emergency service personal may still increase the efficiency and safety with which emergency-service personnel arrive at their destinations. This occurs from use of the efficient routing system alone.

Routing systems constructed according to embodiments of the present invention may not only employ selective routing to avoid traffic bottlenecks and dangerous roads and intersections, but may employ predictive routing to avoid forecasted conditions, such as forecasted traffic congestion. This may further improve traffic flow and road safety.

Hence, usage of certain embodiments of the present invention may facilitate locating and acquiring products and/or services; may optimally route users between product/service locations; may improve traffic flow; may reduce traffic congestion, and so on, thereby saving users time and money. Reduced traffic congestion may reduce air pollution and fossil fuel consumption, which may reduce greenhouse gasses and may lower the demand for fuel, thereby further lowering fuel prices. Additional potential benefits include reduced vehicle maintenance costs, reduced road-maintenance costs, and improved highway safety.

### BRIEF DESCRIPTION OF THE DRAWINGS

FIG. 1 is a diagram of an exemplary system for facilitating acquisition of one or more products and/or services by a customer.

FIG. 2 is a more detailed block diagram illustrating a routing system adapted for use with the system of FIG. 1 that facilitates selecting a route between a first location and a second location.

FIG. 3 is a flow diagram of a method adapted for use with the system of FIG. 1.

FIG. 4 is a diagram illustrating an inventory-search network adapted for use with the system of FIG. 1.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

For clarity, various well-known components, such as power supplies, analog telephone adapters, gateways, firewalls, 802.11 access points, the Public Switched Telephone Network (PSTN), and so on, have been omitted from the figures. However, those skilled in the art with access to the present teachings will know which components to implement and how to implement them to meet the needs of a given application.

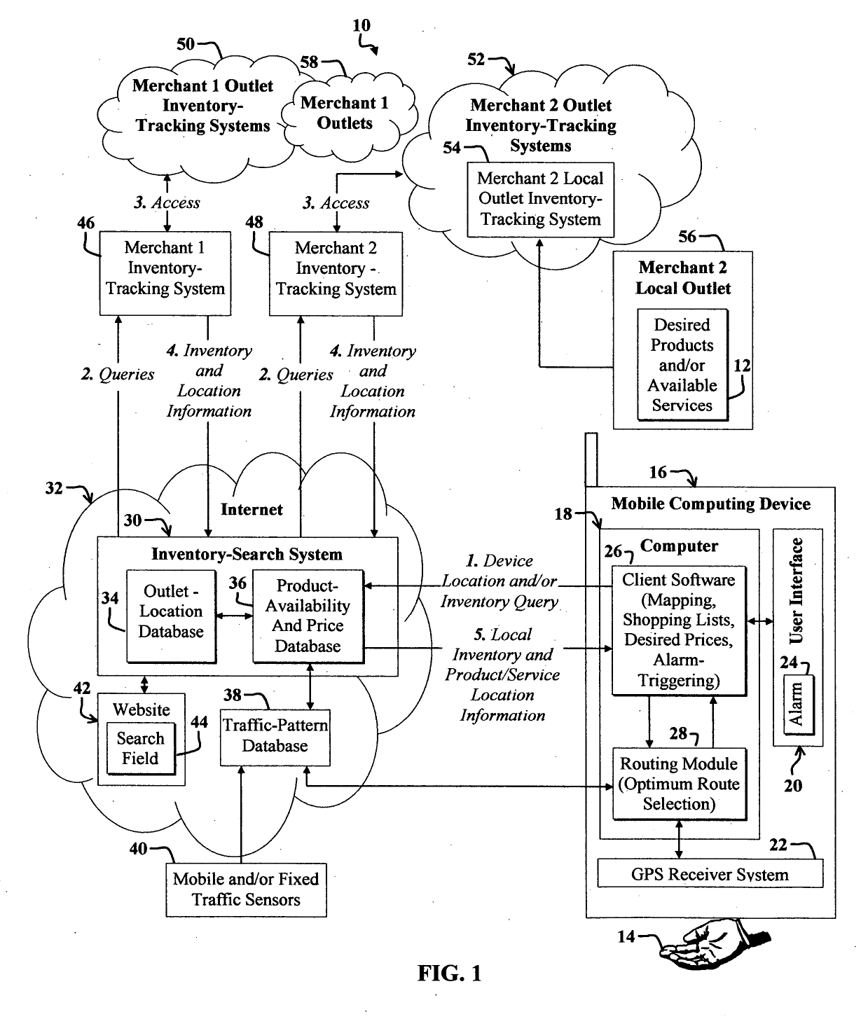

FIG. 1 is a diagram of an exemplary system 10 for facilitating acquisition of one or more products and/or services 12 by a customer 14. The system 10 includes a web-enabled mobile computing device 16 that includes a computer 18 with a Global Positioning System (GPS) receiver system 22 and a user interface 20 with an alarm 24. The computer 18 includes client software 26 that communicates with an accompanying routing module 28. The client software 26 implements mapping functions, shopping lists, alarm activation, and other routines. The routing module 28 facilitates selecting optimal routes, as discussed more fully below.

The client software 26 communicates with an inventory-search system 30 via the Internet 32 or other network. The inventory-search system 30 includes an outlet-location database 34 in communication with a product-availability and price database 36. The product-availability and price database 36 communicates with a traffic-pattern database 38. The routing module 28 running on the computer 18 of the mobile computing device 16 communicates with the traffic pattern database 38 via the Internet 32 or other network. The traffic-pattern database 38 also receives input from various mobile and/or fixed traffic sensors 40.

The inventory-search system 30 is accessible directly via the mobile computing device 16 and the Internet 32, and/or via a website 42 that includes a search routine and accompanying search field 44. The mobile computing device 16 may be employed to browse to the website 42 to facilitate communicating with the inventory-search system 30 and/or may connect to the inventory-search system 30 without employing the website 42.

In the present specific embodiment, the inventory search system 30 communicates with various merchant inventory-tracking systems, including a first inventory-tracking system 46 and a second inventory-tracking system 48. The inventory-tracing systems 46, 48 communicate with inventory-tracking systems of associated outlets. For example, the first merchant inventory-tracking system 46 communicates with a first set of outlet inventory-tracking systems 50 associated with the first merchant inventory-tracking system 46. Similarly, the second merchant inventory-tracking system 48 communicates with various outlet inventory-tracking systems 52, which include, for illustrative purposes, a local inventory-tracking system 54. The local inventory-tracking system 54 maintains inventory information for a local outlet 56. The inventory information includes information associated with the desired products and/or available services 12. This inventory information may include product location information, such as GPS coordinates, that specify where the local outlet 56 is located and that further specify where a desired product and/or service is located within a particular outlet, such as a store or warehouse. The inventory information may also include price and availability information, including forecasted availability if available.

For the purposes of the present discussion, independent businesses may be separately owned businesses. In the present specific embodiment, merchants associated with the first merchant inventory-tracking system 46 and the second inventory-tracking system 48 are independent businesses. Furthermore, for the purposes of the present discussion, the location of the user 14 represents the location of the mobile computing device 16.

An emergency vehicle may be any vehicle designated by the system 10 as a high-priority vehicle to be avoided by other vehicles, devices, and users of the system 10. Emergency vehicles may include ambulances en route to an accident, police cars en route to a crime, a presidential motorcade, a suspect fleeing law enforcement during a high-speed chase, and so on.

Map information may include any information available on a map. Examples of map information including road patterns and address locations. Traffic information may include any information pertaining to traffic flow. Examples of traffic information include average traffic speeds, average traffic acceleration or deceleration information, traffic-light pattern information, vehicle-accident locations, road-safety parameters, road-condition parameters, and so on.

In operation, the system 10 may implement various operational modes for various applications. In a first operational mode, the user 14 employs the user interface 20 to enter a description of one or more desired products and/or services into the computer 18. The client software 26 receives the product/service description from the user interface 20. The client software 26 also receives current GPS user-location information from the GPS receiver system 22 via the routing module 28. The GPS user-location information specifies the current location of the mobile computing device 16. The client software 26 incorporates the GPS user-location information and the product/service description into one or more queries.

In the present specific embodiment, the queries, which contain the user-location information and information pertaining to the desired products and/or services 12, are forwarded to the product-availability and price database 36 running on the inventory-search system 30. Communications between the mobile computing device 16 and the inventory-search system 30 and traffic-pattern database 38 may be implemented via a wireless connection to the Internet 32; a direct wireless connection to the inventory-search system 30; a landline wired network, or other mechanism. Furthermore, communications from the mobile computing device 16 may be routed through the website 42 in certain applications or implementations. In addition, the mobile computing device 16 may be replaced with a stationary-computing device in certain implementations.

The product-availability and price database 36 maintains current inventory information pertaining to the inventories of participating merchants, which are associated with the first merchant inventory-tracking system 46 and the second merchant inventory-tracking system 48. When inventory associated with various merchant outlets change, the changes are automatically reflected in the merchant outlet inventory-tracking systems 50, 52, which are then reflected in the merchant inventory-tracking systems 46, 48, which track inventory information for associated outlets, such as the merchant outlet 56. Changes to inventory in local outlet inventory-tracking systems 52, such as in the second merchant local outlet inventory-tracking system 54, propagate to the product-availability and price database 36. The inventory-search system 30 may periodically query the merchant inventory-tracking systems 46, 48, such as via Structured Query Language (SQL) queries, for current inventory information or may directly integrated with or networked to the corresponding inventory-tracking systems 46, 48, which may be implemented via database systems, such as Oracle, Sybase, Informix, and so on.

The inventory-search system 30 may also periodically update outlet-location information, which is stored in the outlet-location database 34. In the present specific embodiment, the outlet location information includes GPS coordinates associated with each outlet and further includes GPS coordinates associated with each of the desired products and/or available services 12. The location of available services may correspond to the GPS coordinates pinpointing a service desk within a warehouse or store. Similarly, the GPS coordinates associated with a particular product are preferably sufficiently detailed to enable the user 14 to generally locate the product 12 when the user 12 is within the merchant outlet 56. Embodiments of the present invention that use GPS data to facilitate locating products and services within outlets are particularly useful when locating products and/or services in large stores and warehouses.

In the present embodiment, the merchant inventory-tracking systems 46, 48 are networked with the corresponding outlet inventory-tracking systems 50, 52. Such networking may be performed via one or more Wide Area Networks (WANs), Local Area Networks (LANs), the Internet 32, and/or other network. Database connectivity between the databases may be implemented via various well-known methodologies, such as SQL, Open Database Connectivity (ODBC), Database Interface (DBI)/Database Driver (DBD) connectivity, and so on. The inventory-tracking systems 46-54 may be implemented via one or more data-center networks.

Upon receiving the queries from the client software 26 running on the computer 18 of the mobile computing device 16, the inventory-search system 30 runs routines to selectively access the product-availability and price database 36 and outlet-location database 34 to determine the GPS coordinates of the available desired products and/or services 12. The outlet-location database maintains not only GPS coordinates associated with a particular address, but also detailed GPS coordinates specifying product/service locations within a particular outlet. Such detailed GPS coordinates enable users to pinpoint product/service locations within a particular outlet. This feature benefits from newly afforded accuracy of civilian GPS systems. Such accuracy was previously only enabled for military purposes.

Specific GPS coordinates associated with particular products and/or services may be entered into inventory-tracking systems, such as the local outlet inventory-tracking system 54, via personnel of participating merchant outlets, such as the local merchant outlet 56. Information about where products are shelved in a particular outlet will provide additional benefits to merchants by facilitating restocking and other tasks.

Upon determining the address and/or GPS coordinates of a particular desired outlet 56 and any available specific GPS coordinates pinpointing locations of the desired products/services 12 within the local outlet 56, the routing module 28 then facilitates selecting an optimal route between the mobile computing device 16 and the desired products/services 12.

The routing module 28 employs the current location of the user 14 obtained via the GPS receiver system 22, current traffic patterns and projected traffic patterns from the traffic-pattern database 38 and currently stored map information to select an optimal route between the user 14 and the desired products/services 12. The traffic information obtained by the routing module 28 from the traffic-pattern database 38 includes current traffic speeds at various map locations. These traffic speeds may be obtained from various mobile and/or fixed traffic sensors 40 positioned along highways and roads. Note that currently, traffic flow information from traffic sensors is available via the Internet at websites such as www.sigalert.com. Furthermore, the mobile computing device 16 may report to the traffic-pattern database 38 the current position, speed, acceleration, and other information pertaining to the mobile computing device 16. This information may be obtained via the GPS receiver system 22 and then forwarded to the traffic-pattern database 38 via the routing module 28. The mobile computing device 16 may also include additional sensors, such as optical sensors that sense current traffic light status of any traffic lights that are visible to the optical sensors. Preexisting optics on camera phones may be employed to act as the optical sensors. The traffic-pattern database 38 may employ this traffic-light information to determine traffic light patterns for use in predictive routing incorporating traffic light pattern information.

The traffic-pattern database 38 runs additional predictive algorithms to predict or estimate, based on past traffic-flow information, what traffic speeds and/or traffic light-configurations will be at specific times. Predictive algorithms may be implemented by various data-analysis techniques, such as by computing moving averages and extending them in time; fitting the data with cubic spline polynomials, and extending the polynomials in time to obtain estimates of future traffic information; fitting the data with a least-squares fit and projecting the resulting fit forward in time, and so on. Those skilled in the art with access to the present teachings may readily implement appropriate traffic-prediction routines without undue experimentation.

Alternatively, these predictive algorithms may run on the routing module 28 instead of or in addition to running on the traffic-pattern database 38. Note that the routing module 28 may automatically update map information from online databases, such as the traffic-pattern database 38, to ensure that the latest road-closure information, road name changes, and so on, are considered when selecting optimal routes.

The routing module 28 employs an internal electronic up-to-date map to select several candidate routes between the mobile computing device 16 and the local outlet 56 having the desired products/services 12; The routing module 28 then employs travel distances associated with each route and traffic speeds along each route in combination with predictions of traffic speeds at particular arrival times along each route to select a route that will most quickly and/or efficiently enable the user 14 to arrive at the local outlet 56 and obtain the desired products/services 12. Exact details of the predictive routines incorporating projected traffic patterns is application specific and may readily be determined by those skilled in the art to meet the needs of a given application without undue experimentation. The predictive routines running on the traffic-pattern database 38 and/or the routing module 28 may employ predictions of traffic light states upon arrival at particular locations along a route to facilitate selecting an optimal route as discussed more fully below.

The mobile computing device 16 may be implemented via a computer mounted within an automobile that communicates with the in-car navigation system. Alternatively, certain wireless phones are increasingly incorporating advanced computing features, operating systems, web-accessibility, and expandability that facilitate implementing the modules of the mobile computing device 16. Such wireless phones often combine cellular technologies with pocket-computer technologies to enhance functionality. For example, an Ipaq Pocket PC (pocket Personal Computer) may be fitted with a sleeve that accepts a GPS antenna. Pocket PC may connect to a wireless phone via a cable, thereby enabling Internet access. One skilled in the art may modify and augment currently available GPS navigation and routing software for Pocket PCs, such as that made by Teletype GPS (www.teletype.com), to implement embodiments of the present invention without undue experimentation.

Hence, the user 14 may employ the system 10 to facilitate obtaining the desired products and/or services 12. The system 10 enables a user to quickly locate an outlet 56 having the desired products and/or services 12 available and then be routed to the outlet 56 via a preferred route. The system 10 may employ traffic information, such as vehicle speeds along a proposed route, traffic signal timing information, traffic pattern timing information, and other map information to compute an optimal route between the current location of the mobile computing device 16 and accompanying user 14 to the desired products and/or services 12. Traffic pattern timing information may include predetermined information indicating when certain roads are congested. For example, during rush hour, certain roads may be consistently more congested than others. The system 10 may employ this traffic pattern information in combination with a prediction of when the mobile computing device 16 will arrive at a given road or highway to select a route that minimizes user travel time. Hence, unlike conventional routing systems, the system 10 is capable of performing predictive routing, such that a preferred route is based on predictions of traffic patterns, traffic light information, and so on, at a user's projected time of arrival at a particular en route point.

This predictive routing enables an additional significant and potentially unexpected result. Namely, as a user increases the efficiency and speed with which they arrive at a particular location, and they circumvent traffic bottlenecks and thereby do not further contribute to those traffic bottlenecks. Consequently, as usage of the system 10 increases, instances of traffic jams decrease. Reduced traffic jams result in reduced air pollution and reduced consumption of fossil fuels and reduced production of greenhouse gasses. As motorists reach their destinations more quickly, without wandering between outlets looking for particular products and/or services, overall highway usage decreases, which may further reduce highway and road maintenance costs. Reduced driving times yield reduced automotive maintenance costs.

This predictive routing capability provides further benefits when employed by emergency services vehicles, such as ambulances, fire trucks, and so on. When such emergency vehicles use the system 10, their routes may be made available to the system 10 so that users of the system 10 are given routes that do not intersect the routes selected by emergency vehicles and/or are given routes that prevent users from crossing the paths of the emergency vehicles simultaneously. Furthermore, the built-in alarm 24 may be employed to notify users when they are within a predetermined distance of an emergency vehicle employing the system 10.

The exact path or proposed route of an emergency vehicle may be illustrated on a map displayed via the user interface 20. However, preferably this display feature may be selectively disabled by the emergency vehicles, such as law-enforcement vehicles that do not want their position to be known.

Additional benefits are afforded by use of the accurate GPS receiver system 22 and the detailed product/service-location information collected by the inventory-search system 30. Namely, the routing module 28 may employ the accurate GPS user-location information from the GPS receiver system 22 in combination with accurate product/service-location information from the inventory-search system 30 to pinpoint the location of the desired products and/or services 12 within a particular outlet, such as a warehouse. Consequently, for example, the user 14 may enter a large warehouse or multi-level shopping center 56 and walk directly to the general location of the desired product and/or service 12 within the warehouse or shopping center 56. This may save the user 14 time that would otherwise be spent wandering the isles of the warehouse or asking warehouse personnel for assistance in locating the desired products and/or services 12. Use of the system 10 saves warehouse staff additional time that would otherwise be spent helping customers locate the desired products and/or services 12 within the warehouse 56. This may enable the owner of the merchant outlet 56 to more efficiently use employee resources. Such results represent potentially significant beneficial previously unexpected results.

Furthermore, the user 14 may configure the client software 26 running on the computer 16 to enable activation of the alarm 20 when the user 14 and accompanying mobile computing device 16 are in proximity to the desired products and/or services 12. In this operational mode, a user may enter various desired products and/or services, such as a shopping list. As a user drives around town, the system 10 may alert the user 14 when the user 14 passes a store or other merchant outlet 56 having one or more of the desired products and/or services 12 available. The user 14 may further configure the system 10 so that the alarm 24 is activated only upon passing an outlet that has all of the desired products and/or services 12 available at a desired total price.

Use of the alarm 24 to notify users when they are in proximity to desired products and/or services 12 may enable users to accomplish plural tasks in one trip that would otherwise require multiple separate trips. For example, as a user 14 is driving to meet a friend, the alarm 24 may indicate that the user 14 is passing an outlet 56 that has a particular guitar 12 that the user 14 was interested in purchasing. Consequently, the user 14 enters the outlet 56 and buys the guitar 12 without having to make a separate trip. Consequently, the system 10 may reduce overall traffic in a particular town by facilitating accomplishing multiple tasks in one trip. An overall reduction in traffic may provide additional economic benefits to society, as less productive time is spent idling on freeways and roads.

The system of FIG. 1 may be particularly useful for delivery agents and/or services, such as courier services, the United States Post Office, and businesses employing U.S. Pat. No. 6,862,572, issued Mar. 1, 2005 and entitled SYSTEM AND METHOD FOR FACILITATING INTERACTION BETWEEN BUSINESSES, DELIVERY AGENTS, AND CUSTOMERS, which is herein incorporated by reference. Delivery agents and accompanying vehicles employed in implementations of the above-identified U.S. Patent may incorporate computer systems in communication with accompanying sensors, including traffic-speed sensors, traffic-light sensors, and so on. Such computer systems may wirelessly communicate sensed traffic information to the traffic pattern database 38 for use by other devices, such as the mobile computing device 16. Such computer systems running on delivery-agent vehicles may also incorporate the functionality of the mobile computing device 16.

The system 10 may employ an embodiment of the above-identified U.S. Pat. No. 6,862,572 to send an order from the device 16, such as an order for a drink at a crowded bar. In this example, the GPS coordinates of the user 14 are forwarded to the delivery system of said U.S. Patent by the mobile computing device 16, which relays the user's current GPS coordinates along with the order, to the closest outlet, which may correspond to the bar that user is currently in. One or more of the bartenders or other personnel may then observe the order and the location of the user 14 within the bar to facilitate completing the transaction.

The system 10 may provide further particularly beneficial results when used in other applications. For example, the system 10 may help law enforcement personnel capture fleeing suspects. Law enforcement may employ a GPS-tagging system to tag and track a fleeing vehicle. One such GPS-tagging system is disclosed in U.S. Patent U.S. Pat. No. 6,246,323, entitled METHOD AND SYSTEM FOR TRACKING A VEHICLE, which is herein incorporated by reference. The GPS-tagging system employs a transmitter embedded in a carrier that sticks on the vehicle when launched at the vehicle. The transmitter broadcasts a signal containing detailed GPS location information pinpointing the fleeing vehicle. Various vehicle-tracking systems, such as LoJack® may be employed to provide detailed GPS location or position information without departing from the scope of the present invention.

The detailed GPS position information pertaining to a fleeing vehicle is employed by the routing module 28, which selectively references the traffic-pattern database 38 to facilitate selecting an optimal route between a given law-enforcement vehicle and the fleeing vehicle. The traffic-pattern database 38, with knowledge of current routes of emergency vehicles, may route other users of the system 10 so that they do not cross paths with the law-enforcement vehicles pursuing a suspect. Note that the projected possible routes of the law-enforcement vehicles may be dynamically adjusted virtually in real time as the fleeing vehicle changes position. Consequently, the traffic-pattern database 38 may run routines sufficient to route other users so that they avoid a predetermined region about the current location of the fleeing vehicle and the pursuing law-enforcement vehicle(s). The locations and positions of law-enforcement vehicles may be transparent to the users, thereby preventing a fleeing suspect from knowing the positions of law-enforcement vehicles.

Use of the system 10 in combination with vehicle-tracking systems may provide additional potentially significant unexpected results. Namely, routes traveled by the law-enforcement vehicles or other emergency vehicles rushing to the scene of a crime or accident become less congested, which reduces chances for accidents and innocent bystander casualties. Furthermore, the system 10 may reduce suspect apprehension times and rescue times.

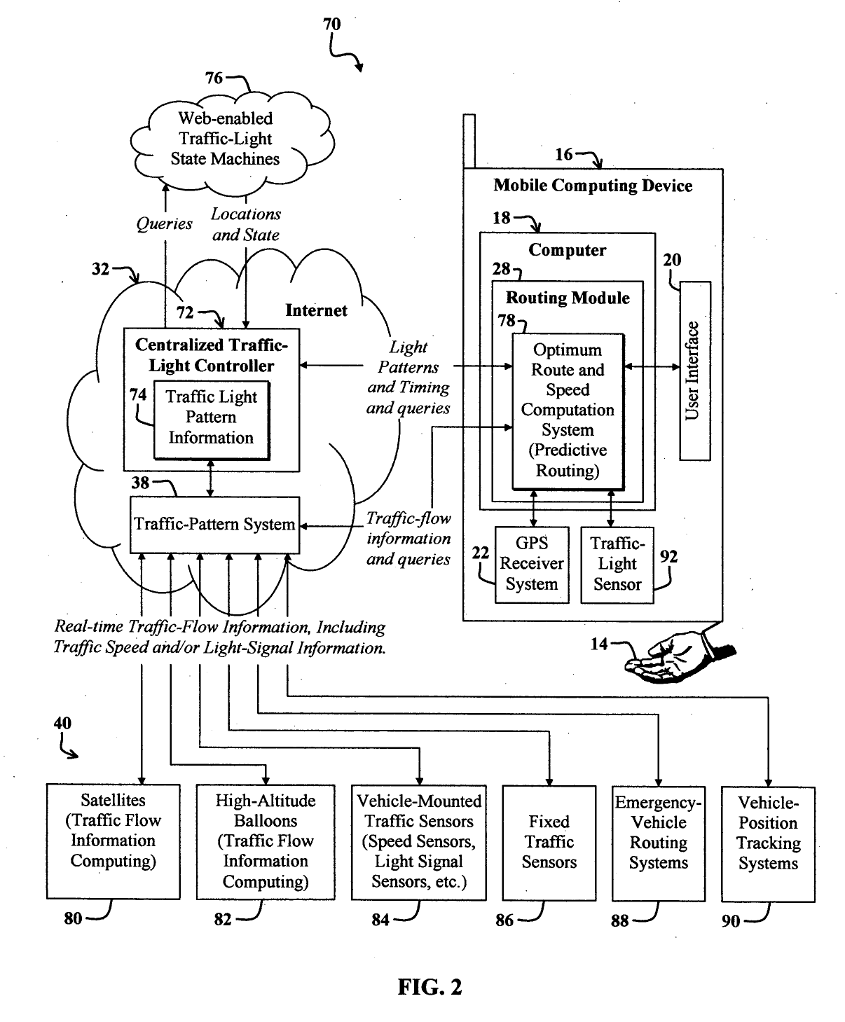

FIG. 2 is a more detailed block diagram illustrating a routing system 70 adapted for use with the system 10 of FIG. 1. The routing system 70 facilitates selecting a route between a first location, such as the current location of the mobile computing device 16, and a second location, such as the location of the local outlet 56 of FIG. 1. The routing system 70 includes the mobile computing device 16 in communication with the traffic-pattern database 38 and a centralized traffic-light controller 72, which intercommunicate. The centralized traffic-light controller 72 maintains traffic-light pattern information 74 and communicates with networked traffic-light state machines 76, the traffic-pattern database 38, and communicates with an optimum route and speed computation system 78 running on the routing module 28 of the computer 18 of the mobile computing device 16. The traffic-pattern database 38 communicates with the optimum route and speed computation system 78, which is also called a predictive router, and communicates with various sensing systems 40, including satellites 80, sensors mounted on high-altitude balloons 82, vehicle-mounted sensors 84, fixed traffic sensors 86, emergency-vehicle routing systems 88, and vehicle-position tracking systems 90. The predictive router 78 running on the mobile computing device 16 communicates with the GPS receiver system 22 and a traffic-light sensor 92. Various modules of the mobile computing device 16, such as the GPS receiver system 22 and the traffic-light sensor 92 may be implemented separately and not incorporated within the mobile computing device 16 without departing from the scope of the present invention.

In operation, with reference to FIGS. 1 and 2, the user 14 employs the mobile computing device 16 to facilitate selecting a destination location, such as the local outlet 56 of FIG. 1. The predictive router 78 then employs the destination location and the current location of the user 14, which corresponds to the position of the mobile computing device 16 in the present embodiment, as provided by the GPS receiver system 22; to select a preferred route between the current location and the destination location.

To select a preferred route, the predictive router 78 selectively accesses the traffic-pattern database 38 and the centralized traffic-light controller 72 to obtain all available traffic information pertaining to a predetermined region encompassing the current location and destination location. The predictive router 78 then performs a route search, searching possible routes between the current location and destination location, while considering the available traffic information, to determine the quickest path between the locations.

In the present specific embodiment, the traffic information includes predictions of traffic flow at specific times as calculated by the traffic-pattern database 38 and/or the centralized traffic-light controller 72. Alternatively, traffic-flow prediction calculations may be performed via routines running on the predictive router 78. The traffic-flow predictions may be performed based on historical data stored on the predictive router 78 or downloaded from the traffic-light controller 72 and/or the traffic-pattern database 38. Various predictive algorithms may be employed without departing from the scope of the present invention, including various algorithms conventionally employed to predict the movement of financial markets, such as neural network algorithms.

In an alternative methodology, the predictive router 78 preselects plural candidate routes between the current location and the destination location based on current map information stored on the computer 18 and/or accessed via the Internet 32. The candidate routes include plural shortest-distance routes. For example, the predictive router 78 may initially select the ten shortest routes between the current location and the destination location. The best route is then selected from the ten initially selected routes. To select the best route, the predictive router 78 references traffic flow velocities and predictions of traffic flow velocities to determine where the user 14 will be en route at specific times. Based on knowledge of where the user 14 will be en route, the predictive router 78 can estimate or predict what the status of any applicable en route traffic lights will be; predict the estimated duration of any red lights; and predict duration of time spent at particular traffic bottlenecks, and so on. The predictive router 78 considers such predictions as the predictive router 78 runs calculations for each of the ten preselected routes. The route resulting in shortest travel time is, by default, the selected route.

However, the user 14 may employ the user interface 20 to configure the predictive router 78 to consider other factors, other than time, when selecting a preferred route. For example, the user 14 may employ the predictive router to select the least dangerous route based on available accident data, which may include the times and locations at which accidents are most likely to occur. By avoiding dangerous locations, such as dangerous intersections, users of the system 70 may reduce the chance of accidents. As usage of the system 70 increases, incidents of accidents in general may also decrease.

The predictive router 78 may employ a weighting function that enables the user 14 to weight specific priorities, such as time versus safety. For example, the weighting function may take the following form:
W=aWₛ+bWₜ [1]
where W is the total weight; a and b are user-adjustable coefficients; Ws is a function of route safety; and Wt is a function of estimated en route time. Consequently, if the user 14 wishes that the predictive router 78 consider only time when selecting the preferred route, then the user 14 may set a=0. Similarly, if the user 14 prefers that the predictive router 78 consider only safety when selecting the preferred route, then the user 14 may set b=0. Similarly, if the user 14 would like the predictive router 78 to consider safety and en route time equally, then the user 14 selects a=b<>0.

Factors other than safety and estimated en route time may be employed without departing from the scope of the present invention. For example, a bicyclist employing the mobile computing device 16 may decide to select the flattest route with the least elevation gain and drop. Information pertaining to the flattest route is considered map information that may preloaded in the computer 18 or downloaded from the Internet 32, such as via the traffic-pattern database 38, which may also maintain current map information. As another example, a person driving very low-profile vehicle may wish to select a route associated with the roads that are in the best condition, such as lacking pot holes, speed bumps, and so on. Such road-condition information is also considered map information that may be available via the traffic-pattern database 38 or other map-information source. Truck drivers may wish to select routes that lack low tunnels or otherwise provide ample clearances for trucks. Additional factors that may be considered by the predictive router 78 when selecting a preferred route may include estimated locations and positions of emergency vehicles, such as ambulances, presidential motorcades, and so on. Such additional information is available via the traffic-pattern database 38.

The safety factor Ws may be quantified, for instance, by associating various safety levels with numbers. For example, relative safety of an intersection or portion of a route may be assigned a safety value on a scale of 1-10, with 10 being the safest and 1 being the most dangerous. The safety values may vary with time. For example, certain intersections may become more dangerous during rush hour traffic. In this implementation, Wt may be normalized to a range between 1-10, with 1 being associated with the slowest route and 10 being associated with the fastest route. This facilitates computing the total weight W while enabling the coefficients a and b to equivalently contribute to weighting Ws and Wt.

In an illustrative embodiment, the total weight W incorporates a road-condition weight Wc in addition to Ws and Wt so that equation (1) now reads:
W=aWₛ+bWₜ+cW_{c} [2]
where c is also user-adjustable coefficient. The various coefficients a, b, and c may be entered via the user interface 20, and the weighting equations (1 and 2) may be implemented in the predictive router 78 and considered by the predictive router 78 when selecting the preferred route. In an embodiment where Ws and Wt are mapped to ranges between 1 and 10, Wc is also mapped to a range between 1 and 10, such that roads, intersections, associated routes, and so on, are rated based on condition on a scale of 1 to 10, with 1 associated with the worst condition and 10 being associated with the best condition. In the present specific embodiment, routes associated with larger values of W for a given set of coefficients (a, b, c) are considered preferable to those associated with smaller values of W.

In the present specific embodiment, the traffic-pattern database 38 may collect traffic information from plural sources, including the satellites 80, high-altitude balloons 82, vehicle-mounted traffic sensors 84, fixed traffic sensors 86, emergency-vehicle routing systems 88, vehicle-position tracking systems 90, and the centralized traffic-light controller 72. The satellites 80 may provide near-real-time traffic flow imagery from which speeds along various streets, roads, and highways can be extracted graphically. Special high-altitude balloons may provide similar imagery from which traffic speeds and other information may be calculated. Traffic-speed calculations based on video from satellites and/or balloons may be computed via modules included within the satellites 80 or balloons 82, or may be computed via modules and routines associated with or incorporated within the traffic-pattern database 38. The traffic-pattern database 38 may act as more than a conventional database. The traffic-pattern database 38 may act as a central hub or server system for collecting and distributing traffic and map information from various sensing systems, including the systems 80-90, and for calculating projected traffic patterns.

The vehicle-mounted traffic sensors 84 may include various traffic sensors, including GPS systems and backup speed sensors that interface with automobile speedometers and relay speed and location information to the traffic-pattern database 38. The vehicle-mounted traffic sensors 84 may also include optical sensors that are adapted to relay traffic light state information to the traffic-pattern database 38 for further light-pattern analysis.

The fixed traffic sensors 86 may include conventional sensors that calculate average traffic speeds along select routes. Average traffic speeds along given routes may be forwarded to the traffic-pattern database 38. Various sensors that are currently in use along various major highways may be employed to facilitate implementing embodiments of the present invention without departing from the scope thereof

The emergency-vehicle routing systems 88 may include emergency vehicles employing the systems 10 and 70 of FIGS. 1 and 2, respectively. Such emergency vehicles will employ the mobile computing device 16 to select optimal routes from their current position to desired destination locations. These selected routes may be forwarded by the mobile computing device 16 to the traffic-pattern database 38 to facilitate any predictive routing calculations performed by the traffic-pattern database 38. Mobile computing devices 16 employed by emergency-vehicles may be equipped with a routing module that provides an additional indication to the traffic-pattern database 38 specifying that the route information forwarded to the traffic-pattern database 38 corresponds to the route of an emergency vehicle. The traffic-pattern database 38 then employs this emergency-vehicle-route information when computing preferred routes for other mobile computing devices 16.

Alternatively, such predictive routing calculations are not performed by the traffic-pattern database 38. Instead, emergency-vehicle route information stored in the traffic-pattern database system 38 is selectively accessible by routing modules 28 of the participating mobile computing devices. The predictive routing calculations are then performed by the associated predictive routers 78 with knowledge of current emergency-vehicle routes. The mobile computing device 16 and various modules 72, 38, and 80-90 may share computing resources as needed to meet the needs of a given implementation.

The vehicle-position tracking systems 90 may forward, to the traffic-pattern database 38, route information pertaining to the current positions and projected routes of suspects fleeing police and the routes of the police vehicles pursuing the fleeing vehicles. The vehicle-position tracking systems may include LoJack®, and related systems. Such information may be employed by the traffic-pattern database 38 and accompanying routing modules 28 to enable users of the mobile computing device 16 to be routed to avoid interfering with police vehicles in pursuit of suspects.

Note that the user 14 may employ the system 70 to determine an optimal route between any given initial location, not just the current location of the mobile computing device 16, and one or more destination locations. In this application, the user 14 employs the user interface 20 to enter the initial position, any en route positions, and a destination position into the predictive router 78. The predictive router 78 then selectively accesses the traffic-pattern database 38 and/or the centralized traffic-light controller 72 to facilitate selecting a preferred route between the positions.

The centralized traffic-light controller 72 corresponds to various centralized municipal traffic-light control systems employed by municipalities to regulate traffic flow within a given city or town. The traffic-light controller 72 may communicate with and selectively affect the operation of various web-enable traffic-light state machines 76. The traffic-light controller 72 may maintain traffic-light pattern information 74 that is accessible by the traffic-pattern database 38 for use by the traffic-pattern database 38 and/or the routing modules 28 in selecting preferred routes.

Additional traffic-light information may be periodically uploaded to the traffic-pattern database system 38 via the traffic-light sensors 92 associated with the mobile computing device 16. In the absence of traffic light pattern information 74 from the centralized traffic-light controller 72, the traffic-pattern database may deduce traffic light patterns based on input from multiple traffic-light sensors 92 over time. Such pattern-recognition may be performed via neural network algorithms running on the traffic-pattern database 38 or other algorithms, which may be readily constructed by those skilled in the art to meet the needs of a given implementation without undue experimentation.

In summary, the system 70 is particularly adapted to improve traffic flow along routes traveled by users of the system 70 by enabling users to avoid congested areas, thereby reducing the amount of congestion in those areas. Traffic flow is further improved by routing users along routes that are optimized to enable users to minimize the number of stops at red lights. The optimum route and speed computation system 78 may also employ additional traffic flow facts to improve selected routes. For example, at many intersections, left turns may take longer to make than right turns. The system 78 may account for such factors when determining the optimum route for the user 14.

The mobile computing device 16 may communicate with one or more computer systems 72 that control and/or monitor traffic light states. The mobile computing device 16 provides position information from the GPS receiver system 22 to the computer system 72 via a wireless or wired link to the Internet 32 or directly to the system 72. The optimum routing system 78 then determines the optimal speed and/or route for the user 14 to drive to reach the desired destination based on information retrieved from the traffic-light controller 72 and/or other systems 38, 76, 80-90. Consequently, the user 14 is more likely to pass all green lights along a given route than a person not employing the system 70. This may result in reduced time spent travelling, reduced fuel consumption, and reduced congestion as more users employ the system 70 and spend less time on the roads.

Embodiments constructed according to the system 70 may particularly benefit from infrastructure established via the system disclosed in U.S. Pat. No. 6,862,572. In particular, the system of U.S. Pat. No. 6,862,572 provides timesaving incentives for independent delivery agents to participate in the system to and equip their vehicles with the system 70 and additional traffic sensors 84. The additional traffic sensors 84 may relay traffic speed and traffic light information to a more central system, such as the traffic-pattern database 38. The traffic-pattern database 38 may then extract traffic-light pattern information and traffic flow pattern information that may be employed to implement predictive routing suggestions that are forwarded by the traffic-pattern database system 38 to the routing module 28. Alternatively, the predictive routing computations are performed by the routing module 28 running on the computer 18 based on pattern information 74 retrieved from the traffic-pattern database 38 and/or the centralized traffic-light controller 72.

The sensors employed by delivery agents participating in the system of U.S. Pat. No. 6,862,572 may include optical sensors that detect traffic-light color changes. Such optical sensors 92 may be included on accompanying mobile computing devices 16. Information pertaining to detected traffic-light color changes can be combined with GPS-derived information to verify current light states at certain intersections. As more traffic-light information, including light timing and location information is retrieved by the traffic-pattern database system 38, more accurate traffic-light pattern information develops. This traffic-light pattern information will be particularly useful by routing routines 78 to suggest optimal driving speeds for the user 14 to enable the user 14 to pass the most green lights. The user may save additional fuel and reduce greenhouse gas emissions by minimizing stops.

Use of the traffic-light pattern information 74 by the routing module 28 represents a form of predictive routing, wherein conditions along the users route are predicted, thereby facilitating selecting an optimal route and/or travel speed for the user 14. When traffic-light state predictions are combined with other traffic flow predictions, the system 70 becomes particularly useful for expediting travel for individual users and alleviating overall traffic congestion.

Additional traffic information, such as traffic speeds at certain locations, may be forwarded by the routing module 28 to the traffic-pattern database system 38 to further facilitate traffic prediction via traffic-forecasting routines running on the traffic-pattern database system 38. Alternatively, such traffic-forecasting routines may include routines running on the optimum route and speed computation system 78 that compute traffic predictions based on aggregated traffic information downloaded from the traffic-pattern database system 38.

In the present specific embodiment, the routing system 70, which is adapted for use with the system 10 of FIG. 1, exhibits a distributed implementation. However, the routing system 70 may be implemented via a centralized database that computes the optimum route between a particular client location and a desired destination and then forwards the optimum route information to the client, which corresponds to the mobile computing device 16.

The system 10 also acts as a location system that facilitates locating products and/or services in outlets 56, 58, as shown in FIG. 1, in vicinity the vicinity of the user 14. For example, as the user 14 passes a particular outlet, for example, the mobile computing device 16 rings, thereby notifying the user 14 that he/she passing an outlet with the desired products and/or services.

Product notifications may be extended to include outlets having an entire shopping list in stock. Furthermore, the user 14 can specify that the alarm 24 will only be triggered when the price of desired products and/or services is below a certain level or is the lowest price seen recently, such as within a predetermined time frame or within a predetermined number of outlets encountered that have the desired products and/or services available.

The system 10 can also compute a total, such that the user 14 can see which outlet has the user's entire shopping list for the least amount of money. As the user 14 travels past a given outlet or store, the user 14 will be able to see, such as via the user interface 20, the inventory in the store based on the current position of the user 14. This can be integrated with or interfaced with the routing system 70 of FIG. 2, which selects the optimum route based on various sensors, such as sensors positioned on delivery vehicles associated with an implementation of U.S. Pat. No. 6,862,572. Alternatively, real-time satellite information may be employed to facilitate determining the optimum route based on existing traffic. The route can be selected based on the locations of desired products and/or services and current and forecasted traffic patterns. Such systems are particularly important for use by the independent delivery agents and emergency-service personnel.

The inventory-search system 30 system may act as an inventory search engine that locates the closest product or service to the user 14 based on an inventory search. The closest product and/or service may be the nearest in terms of not just distance but distance and/or time involved to get there. The time required to get to a location may be estimated based on additional traffic sensor information, such that traffic patterns, stop light behavior, road closures, and so on along various routes to the particular outlet. Hence, such additional information may be employed to facilitate determining the closest or nearest outlet that has a particular service available or product in stock. For example, the user 14 may direct the client software 26 via the user-interface 20 to list all guitars for sale within a three-mile radius of the current location. The located inventory may be graphically displayed via the user interface 20, showing the location of the user 14 relative to the desired products and/or services. The user 14 may then select a desired guitar, for example, by clicking or otherwise selecting the desired guitar via the user interface 20. The software may then access the routing system 70, which determines the optimum route between the current location of the user and the selected guitar. The optimum route may be the shortest route, the quickest route, the safest route, or another desired route.

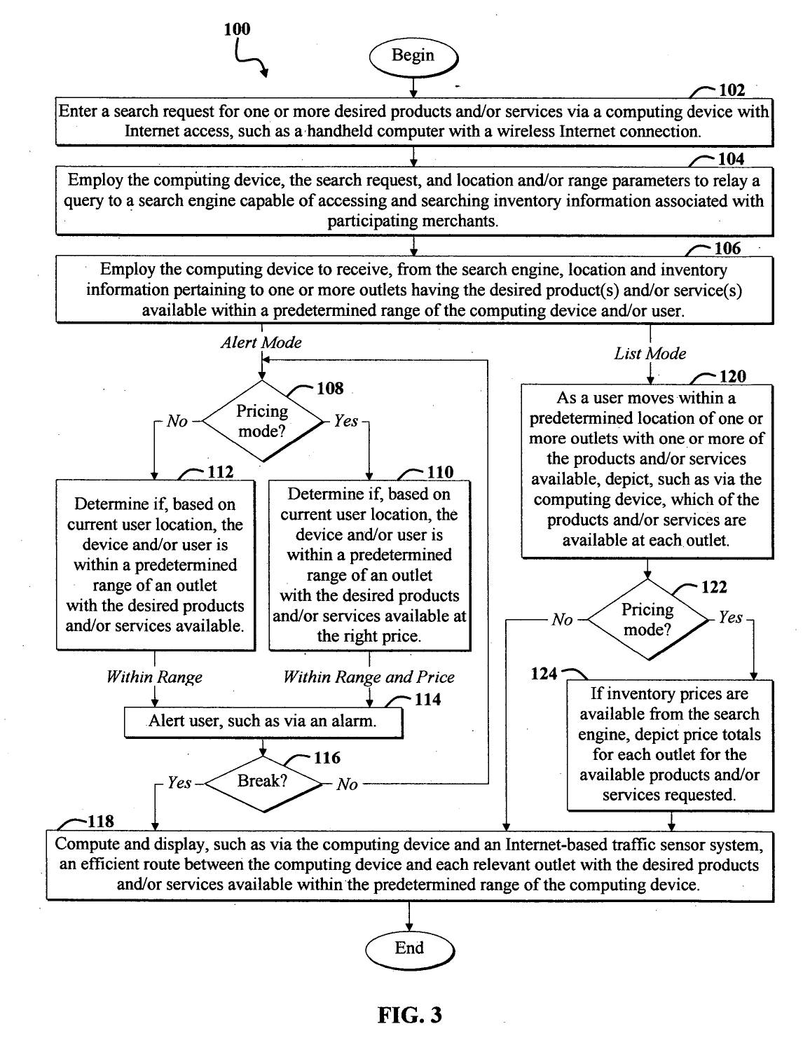

FIG. 3 is a flow diagram of a method 100 adapted for use with the system 10 of FIG. 1. With reference to FIGS. 1-3, in an initial search-request step 102, the user 14 enters a search request for one or more desired products and/or services via the user interface 20 of the mobile computing device 16.

In a subsequent forwarding step 104, the mobile computing device 16 converts the search request into a database query that includes GPS location information from the GPS receiver system 22. The GPS location information specifies the current location of the user 14. The query, which is encapsulated via the client software 26, is forwarded to the Internet-based inventory-search system 30. The inventory-search system 30 then selectively queries the merchant inventory-tracking systems 46, 48 to locate products and/or services that are within a predetermined search range of the mobile computing device 16. The predetermined search range may be user-selected via the user interface 20 and incorporated in the query. Alternatively, the predetermined range is unlimited.

Subsequently, in a result-retrieving step 106, search results from the inventory-search system 30 based on the query are forwarded to the mobile computing device 16. The search results may include detailed GPS location information pertaining to available desired products and/or services within the predetermined range of the mobile computing device 16.

If the client software 26 of the mobile computing device 16 has been configured to operate in alert mode by the user 14 and has been set to operate in pricing mode as determined by the client software 26 in a price-mode-checking step 108, then a range-and-price-checking step 110 is performed next. Otherwise a range-checking step 112 is performed next.

In the range-and-price-checking step 110, the client software 26 monitors the current position of the mobile computing device 16 via the GPS receiver system 22 and compares the current position with the location of desired products and/or services returned from the inventory-search system 30. The software 26 also checks prices associated with the desired products and/or services. The price information is forwarded by the inventory-search system 30 to the mobile computing device 16 in response to the initial query based on the initial search request. When the user 16 is within a predetermined user-selected alert range of the desired products and/or services as determined by the client software 26 with reference to the location of the mobile computing device 16 and the prices and locations of the desired products and/or services, then the alarm 24 is activated in an alerting step 114. The alarm is activated via the alerting step 114 when the prices associated with the desired products and/or services are within a user-selected price range, which may include prices below or above a certain price threshold.

If the client software 26 is not operating in pricing mode, then the range-checking step 112 is performed. The range-checking step 112 is similar to the range-and-price-checking step 110 with the exception that in the range-checking step 112, the user is alerted via the alerting step 114 when the user is within a predetermined alert range of the desired products and/or services regardless of price.

In a subsequent break-checking step 116, the method 100 determines if the user 14 has chosen to be provided with the most efficient route to the desired products and/or services. If the user has chosen, such as via the user interface 20, to be routed to the products and/or services associated with the alarm, then a routing step 118 is subsequently performed. Otherwise, the price-mode-checking step 108 is performed again, creating a loop that exits when the user 14 has decided to be routed to products and/or services within the alert range of the user 14. Additional methods or different methods for exiting the loop formed by the steps 108-116 may be implemented without departing from the scope of the present invention.

In the present specific embodiment, the routing step 118 includes computing and displaying, such as via the mobile computing device 16 and accompanying routing system 70 illustrated in FIG. 1, an efficient route between the mobile computing device 16 and each relevant outlet having one or more of the desired products and/or services available. The one or more relevant outlets are also located within the predetermined user-selected alert range of the mobile computing device 16.

When the mobile computing device 16 operates in alert mode, a relevant outlet is considered to be an outlet associated with the alert activated in the alerting step 114. When the mobile computing device 16 operates in list mode and pricing mode, a relevant outlet is considered to be an outlet that has the desired products and/or services available, and wherein the outlet is within the alert location range of the mobile computing device 16, and wherein the one or more desired products and/or services are within a desired price range. When the mobile computing device 16 operates in list mode and not in pricing mode, then a relevant outlet is considered to be an outlet that has the desired products and/or services available, and wherein the outlet is located within the alert range of the mobile computing device 16.

If after performing the result-retrieving step 106, the mobile computing device 16 is operating in list mode, then a listing step 120 is performed next. In the listing step 120, the mobile computing device 16 lists which products and/or services are available at each outlet within a predetermined range of the mobile computing device 16. Such listing may be performed via the user interface 20, which may be a graphical user interface. The available products and/or services may be listed on the screen of a moving map. The available products/services lists may be superimposed over the locations of the associated outlets having the products and/or services available. Alternatively, the outlets may be color coded on the map so that outlets offering all of the desired products and/or services are a first color, while outlets offering a certain number of the desired products and/or services are another color, and so on. The user may then click on the color-coded outlet to activate a list detailing exactly which products and/or services are available at each color-coded outlet. The product/service price total for each outlet may be indicated along with the color-coded outlet icons when operating in price mode, as discussed more fully below. The moving map may be periodically or continually updated with the current position of the user and the locations of surrounding outlets that have one or more of the desired products and/or services available.

If the mobile computing device 16 is in pricing mode as determined in a second price-mode-checking step 122, then additional price information pertaining to the prices of the desired products and/or services is made available via the graphical user interface 20 in a price-total-depicting step 124. For example, as a user passes within a predetermined range of a store that has all of the user's shopping list available, the mobile computing device 16 may display a price total adjacent to the outlet in a map displayed via the user interface 20. Alternatively, the price information is displayed in response to the user selecting a color-coded icon associated with the outlet that has the products of the shopping list available as indicated by the color of the outlet as displayed on the map illustrated via the user interface 20.

If the mobile computing device 16 is not in pricing mode, then the user is routed to the exact location(s) of the desired products and/or services in the routing step 118. In the routing step 118, the mobile computing device 16 may provided the user 14 with sufficiently detailed location information pertaining to the desired products and/or services to enable the user 14 to determine where in a the store that the desired products and/or services are available. This feature is particularly useful in large warehouse stores, such as Wal-Mart, where finding desired products hidden among many isles may be time consuming and problematic. As GPS location information becomes increasingly accurate, such functionality will become increasingly effective at guiding users to desired products and/or services.

Alternatively, even in situations wherein the GPS signal is too inaccurate to enable price pinpointing of desired products and/or services within a particular store, location information other than GPS information may be employed. For example, if the various merchant inventory-tracking systems 50, 52 also maintain shelving information pertaining to each product in their inventory databases, this shelving information may be forwarded to the mobile computing device 16 via the inventory-search system 30 in response to user product and/or service request queries. The shelving information may then be employed by one or more routines running on the computer 18 to graphically depict the location(s) of desired products and/or services within a particular outlet. The shelving information may obviate the need for accurate GPS location information pertaining to the current position of the user and/or pertaining to the GPS coordinates of shelving locations of products or pertaining to the GPS coordinates of desk/counter locations associated with desired services. Instead, a map of the outlet may be downloaded from the inventory-search system 30, which has retrieved the map from the merchant systems 46, 48, 50, 52. The shelving locations of the desired products and/or services are then highlighted on the map, which is displayed to the user 14 of the mobile computing device 16 either in response to predetermined user input or automatically when the user is within a predetermined range of the associated outlet.

The method 100 and accompanying systems 10, 70 facilitate shopping for products and/or services based on price, location, and/or other factors. Not only do the systems and methods save users time by facilitating locating desired products and/or services, but traffic congestion may be reduced, and the effects of competitive market forces may become amplified, thereby resulting in lower overall user shopping costs as users more easily seek out merchants that provide the lowest total prices.

The method 100 is particularly beneficial for users wishing to locate, for example, the store that will result in the lowest total cost for a given shopping list. The user may run the system from a home computer or from a mobile computing device, such as the device 16, that is GPS and web enabled. Devices other than mobile computing devices may be employed without departing from the scope of the present invention.

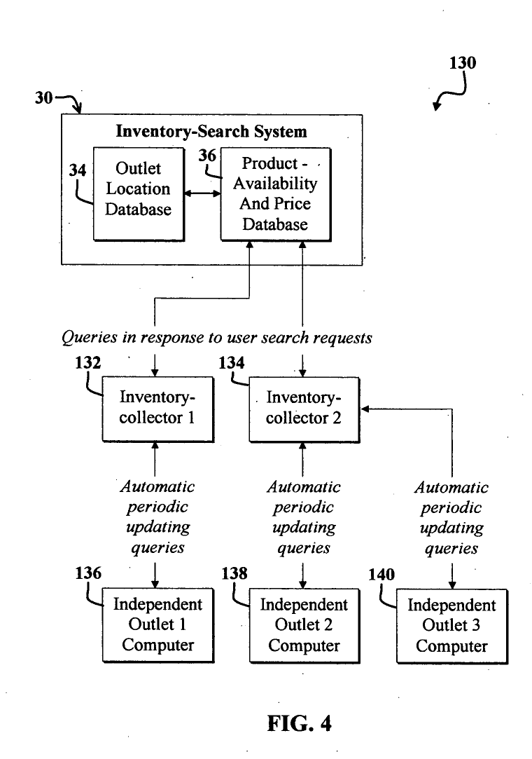

FIG. 4 is a diagram illustrating an inventory-search network 130 adapted for use with the system 10 of FIG. 1. The search network 130 includes the inventory-search system 30, which communicates with plural inventory collectors 132, 134, which include a first inventory collector 132 and a second inventory collector 134. For illustrative purposes, the first inventory collector 132 is shown communicating with a first independent-outlet computer system 136. The second inventory connector 134 is shown communicating with a second independent-outlet computer system 138 and a third independent-outlet computer system 140.

In operation, the inventory collectors 132, 134 periodically automatically query the independent outlet computer systems 136-140 to consolidate inventory information pertaining to the business outlets associated with the outlet computer systems 136-140. By consolidating inventory information, the inventory collectors 132-134 increase the efficiency with which the product-availability and price database 36 can access inventory information. Instead of querying each independent outlet computer system 136-140 each time a user performs an inventory search for a desired product and/or service, the product-availability and price database 36 merely queries the inventory collectors 132, 134.

The exact number of inventory collectors 132-134 and independent outlet computer systems 136-140 is application specific and may be adjusted to meet the needs of a given application. More or fewer independent outlet computer systems and/or inventory collectors may be employed without departing from the scope of the present invention. Furthermore, additional layer of inventory collectors may be employed. For example, a third inventory collector could be inserted between the inventory collectors 132-134 and the product-availability and price database 36 to further consolidate real-time inventory information for immediate access by the product-availability and price database.

The merchant inventory-tracking systems 50-52 may communicate with a central inventory database 36, which communicates with various distributed inventory databases 46,46 via a merchant network. If available, location information forwarded from the inventory access system 30 to the mobile computing device 16 pertaining to the available products in a particular local outlet 12 may contain specific GPS information, address information, product-shelving information, and so on. The location information may be so specific so as to pinpoint where the product is in the particular outlet 56, such as the isle, shelf, or store corner where the product and/or appropriate service desk is located. This reduces the need for customers to roam a store looking for a particular item, thereby saving significant time and freeing store personnel for tasks other than showing customers where products are located within the store.

Hence, the inventory-search system 30 may contain or communicate with the product-availability and price database 36, which may act as a site scanner that communicates with various distributed inventory collectors 132-134 that periodically collect and consolidate up-to-date information from plural inventory systems 136-140. Additional systems may further consolidate inventory information from the inventory collectors 132-134.

In summary, with reference to FIGS. 1-4, the system 10 of FIG. 1 employs the efficient web-and-GPS-enabled mobile computing device 16 to locate one or more desired products and/or services 12. The mobile computing device 16 then provides the user 14 with a preferred route to the desired product(s)/service(s) via the routing module 28. The system 10 employs a unique inventory-search system 30 that may employ distributed inventory/location-information collectors 132, 134, as shown in FIG. 4, to facilitate providing inventory information, including projected inventory information if needed for a particular application.

The system 10 further implements an alert system (see alarm 24 of FIG. 1) that acts as a proximate-inventory-information system that alerts the user 14 with the enabled computer 16 when the user 14 is in proximity to the one or more desired products and/or services 12. With sufficiently detailed product-location information, this system 10 can pinpoint product locations within a store or other outlet 56. The alerting component may be employed in absence of the accompanying routing component 70 without departing from the scope of the present invention. In such a system, a user that is randomly driving or travelling may be alerted when in proximity to one or more desired products and/or services and not necessarily when travelling on a particular route.

Furthermore, the routing system 70 may lack the product-acquisition system 10 without departing from the scope of the present invention. In this implementation, use of predictive routing features and traffic-light pattern consideration to determine an optimal travel-route for a user is particularly beneficial. The system 70 may improve overall traffic flow, minimize starts and stops, and minimize overall travel time, thereby improving overall commuter gas mileage, reducing smog, and improving the speed at which drivers reach their destinations.

The combination of the system 10 of FIG. 1 for efficiently locating desired products and/or services, and routing system 70 is synergistic. In particular, the combination may be employed to find, for example, an optimal route between product/service outlets to improve the efficiency with which a given shopping list is completed, such as by reducing the time and/or money required to obtain items on the shopping list. The resulting system 10 may be employed to find, for example, the least expensive gas station along the user's projected route. This further harnesses competitive forces to facilitate lowering merchandise and service costs. Furthermore, combined system 10 of FIG. 1 is particularly useful for alerting the user 14 when an ambulance or other emergency vehicle is in proximity to the user 14 or is on a route that is projected to intersect the current route of the user 14. This may reduce incidences of accidents between emergency services and users of the systems 10, 70, thereby further contributing to reduced traffic congestion.

The system 10 of FIG. 1 includes a first mechanism for providing a query that contains information pertaining to the one or more desired products and/or services. The first mechanism may be implemented in whole or in part by the mobile computing device 16 and accompanying modules 18-28, in response to input from the user 14. A second mechanism performs an inventory search of multiple independent businesses 50-56 based on the query and provides search results to the first mechanism in response thereto. The second mechanism may be implemented via the inventory-search system 30 in communication with the inventory-tracking systems 46-48. In this embodiment, the search results contain approximately real-time inventory and location information associated with the query.

In the specific embodiment, the query may include price-preference information pertaining to one or more desired prices or price ranges associated with the one or more desired products and/or services 12. The search results may include reported price information associated with the one or more desired products and/or services 12. In such a case, the price-preference information affects the search results.

An additional mechanism employs the reported price information, the inventory information, and the location information in combination with position information associated with a position of a user of the system 10, to selectively alert the user 14 when the user 14 is within a predetermined range of one or more of the one or more products and/or services 12 that are associated with prices that are consistent with the price-preference information. The additional mechanism may be implemented via the computer 18 and accompanying client software 26 associated with the mobile computing device 16. The user 14 may specify price-preference information via the user interface 20.

The query may further include one or more range parameters specifying a desired region about the customer 14 to limit the inventory search. A third mechanism may determine a preferred route between the customer 14 and the desired product or service 12 based on the location information and the inventory information. The third mechanism may be implemented via the routing module 28 in communication with the GPS system 22, which communicates with the first mechanism 16, 18-28.

The GPS receiver system 22 provides customer location information to the routing module 28 of the third mechanism. The user interface 20 of the mobile computing device 16 may be employed to graphically depict and update the optimal route determined by the routing module 28.

The location information may include specific location information sufficiently detailed to indicate a region within a particular outlet 56 wherein the desired product(s) and/or service(s) 12 will be available. The alarm 20 may be employed to alert the customer 14 when the customer 14 is within a predetermined region of the business outlet 56 having the desired product(s) or service(s) 12 available.

The client software 26 may also be adapted to incorporate a shopping list or task list within the query sent to the inventory-search system 30. The software 26 runs routines that selectively activate the alarm 24 when the customer 14 is within a predetermined location of one or more business outlets 56 having the product(s) and/or service(s) 12 of the shopping list or task list available.

The routing module 28 may further include a mechanism for computing a route between plural outlets 56, 58 having the one or more products and/or services available. In one implementation, the route is a quickest route based on map information between the customer and one or more outlets. The quickest route may be further determined based on traffic information, including traffic speeds and/or light signal patterns if available.

The routing module 28 may further determine an optimal speed for the customer 14 to travel en route to the desired product(s) and/or service(s) 12 based on en route traffic information and/or traffic-light patterns. The routing module 28 may obtain the traffic information via the traffic-pattern database 38 and/or the traffic-light controller 72, which manages traffic-light operation. The traffic-light controller 72 provides traffic-light pattern information accessible by the computer 16 for use by the routing module 28.

In the specific embodiment, the routing module 28 includes additional routines 78, which facilitate predicting traffic flow at predetermined future times arrival times at predetermined positions along a route between a current location of the customer 14 and a projected location of the customer 14 and provides traffic flow predictions in response thereto. The routing module 28 then selects an optimal route based on the traffic flow predictions.

The routing system 70 of FIG. 2 implements a system for selecting a travel route for the user 14 between a first location and a second location. The system 70 includes a first module that monitors traffic information. The first module may be implemented via the traffic-pattern database system 38. A second module determines one or more proposed routes between the first location and the second based on map information. A third module employs the traffic information and the one or more proposed routes to select a preferred route between the first location and the second location. The second module and the third module may be implemented via the routing module 28, the traffic-pattern database system 38, and/or another module.

An additional mechanism enables users of the system 70 to avoid accident-prone intersections, roads, and/or other routes. The additional mechanism may be implemented via one or more software and/or hardware routines running on the computer 18 as part of routing module 28. In this implementation, the traffic information may include safety information pertaining to one or more of the one or more proposed routes. The map information may include road-condition information pertaining to road conditions associated with one or more of the one or more proposed routes. The third module 28 employs estimates of route travel time to facilitate selecting the preferred route.

An additional mechanism, which may be implemented via routing module 28, employs a weighting function to weight selection priorities employed by the third module 28 to facilitate selecting the preferred route. The selection priorities are quantified via one or more variables, including the safety variable (Ws), the road-condition variable (Wc), and/or the en route-time variable (Wt) as defined in equation (2).

In another implementation, the third module 28 includes a fourth module, which may be implemented via the optimum route and speed computation system 78, that is capable of projecting estimated traffic information at predetermined times along each of the one or more proposed routes to facilitate determining a quickest route between the first location and the second location.

The optimum route and speed computation system 78 implements one or more routines that employ predictive routing to select the preferred route between the first location and the second location based on projected travel speeds and arrival times at predetermined locations along each of the proposed routes. The first location is a dynamically changing location when it corresponds to the location of the mobile computing device 16 while travelling.

The traffic information may further include traffic-speed information and traffic-light pattern information, which may be provided by plural mobile traffic sensors 84. The traffic information may be provided to the traffic-pattern database system 38, which may be accessible to the mobile computing device 16 via an accompanying website represented by the database system 38.

The traffic information may further include information pertaining to emergency routes selected by emergency vehicles. The routing module 28 includes one or more routines that employ the information pertaining to the emergency routes to ensure that a user 14 following the preferred route does not intersect an emergency vehicle following one of the emergency routes. Additional routines implemented by the routing module 28 notify a user when the user is within a predetermined range of an emergency vehicle employing the system.

One or more of the additional tracking systems 90 may facilitate tracking a location of a vehicle, wherein the location of the vehicle corresponds to the second location. The fleeing vehicle, represented graphically by the tracking systems 90, may represent a vehicle driven by a person that is fleeing law enforcement. The first location may correspond to a location of a law-enforcement vehicle.

The inventory-search system 130 of FIG. 4 is adapted for use with the system 10 of FIG. 1. The inventory-search system 130 includes a mechanism for automatically generating and sending queries to one or more inventory-tracking systems, which are depicted as outlet computer systems 136-140 in FIG. 4. The mechanism for automatically generating and sending queries is implemented via the inventory collectors 132-134, which also implement a mechanism for storing results of the queries. A mechanism for accepting and forwarding one or more user-configurable queries may be implemented via the mobile computing device 16 of FIGS. 1 and 2. The product-availability and price database 36 may implement an additional mechanism for selectively accessing the results in response to the one or more user-generated queries and providing user-requested results in response thereto.

In the specific embodiment, the one or more user-configurable queries include requests for inventory information. The inventory information is associated with a predetermined geographic location or region and one or more desired products and/or services. Another mechanism, which may be implemented by the client software 26, activates an alarm 24 when the mobile computing device 16 is within a predetermined range of the one or more desired products and/or services 12 based on the predetermined geographic location or region and a location of the mobile computer 16.

The Global Positioning System (GPS) receiver system 16 facilitates specifying the location of the mobile computer 16 in the one or more user-configurable queries forwarded to the mechanism for accepting and forwarding one or more user-configurable queries. The results of the queries include GPS coordinate information, which includes detailed coordinate information pertaining to locations of specific products and/or services in a particular outlet. In one implementation, the detailed coordinate information is sufficiently specific to facilitate locating the particular product and/or service within the particular outlet. The results of the queries may further include projected inventory information.

The system 10 of FIG. 1, which is adapted for use with the system 70 of FIG. 2, may further implement a system for alerting the user 14 when the user 14 is in proximity to the desired product or service 12. Such a system 10 includes the inventory-search system 30, and if desired for a particular implementation, the routing system 70 and/or the overall inventory search system 130 of FIG. 1. The inventory-search systems 30, 130 are adapted to collect inventory information associated with one or more outlets 56, 58, and they are adapted to communicate with the mobile computing device 16. The GPS receiver system 22 acts as a location module for providing user-location information associated with the device 16 to the device 16, i.e., to the computer 18 of the device 16. The user interface 20 associated with the device 16 receives, from the user, descriptive information that specifies one or more desired products and/or services 12. The device 16 communicates with one or more routines 26, 28, 36, 78, that employ the user-location information, the descriptive information, and the system 10 to generate a signal when the device 16 is within a predetermined range of the one or more desired products and/or services 12. The user interface 20 provides an indicator or alarm 24 that alerts the user 14 in response to the signal.

Certain routines 26, 28, 78 running on the computer 18 of the mobile computing device 16 may be remotely located relative to the mobile computing device 16 rather than running on the mobile computing device 16. In such an implementation, necessary alert and routing information produced by the routines 26, 28, 78 may be wirelessly forwarded to the mobile computing device 16.

In a specific implementation, the mobile computing device 16 may be a pocket computer, laptop computer, or cellular telephone. The descriptive information, which describes one or more desired products and/or services 12 and that is entered by the user 14 via the user interface 20, may include price information pertaining to a desired price or price range associated with the one or more desired products and/or services 121. In this implementation, the alarm indicator 24 alerts the user 14 when the user 14 is within a predetermined range of the one or more desired products and/or services 12, which are priced in accordance with the price information. The alarm 24 may be implemented as a visual alarm, audio alarm, olfactory alarm, tactile alarm, or other type of indicator, alert, or alarm without departing from the scope of the present invention.

The alerting functionality of the system 10 works synergistically with a mechanism for selecting a travel route between a current location of the device and the one or more desired products and/or services 12. The mechanism for selecting a travel route may include the traffic-pattern database 38 and the routing module 28. The routing module 28 maintains requisite map information that may be selectively updated by downloading updates from the Internet 32.

An additional synergistic mechanism determines when an emergency vehicle, depicted graphically as the emergency-vehicle routing systems 88, has selected a route wherein the emergency vehicle may meet the device 16 at intersecting portions of their travel routes. The additional synergistic mechanism, which may be implemented in part via the traffic-pattern data base system 38, provides an emergency signal to the mobile computing device 16 when an emergency vehicle may intersect the user's path. In response to the emergency signal, the computer 18 of the mobile computing device 16 may indicate to the user 14, such as via a graphic display on a map depicted via the user interface 20, where the intersection is likely to occur.

The additional synergistic mechanism may further be implemented in part via the optimum route and speed computation system 78 of FIG. 2, which is incorporated within the routing module 28 of the computer 18 of the mobile computing device 16. The system 78 in combination with the traffic-pattern database system 38 together act as a route-selection system. The traffic-pattern database system 38 component of the route selection system 38, 78 is accessible via the Internet 32 and communicates with the mobile computing device 16 and emergency vehicles and/or associated emergency vehicle routing systems 88.

The system 10 of FIG. 1 may be considered a system for facilitating acquisition of one or more desired products and/or services 12. In such an implementation, the mobile computing device 16 communicates with a first mechanism that determines when a user of the computing device 16 is within a predetermined range of an outlet 56 having one or more of the one or more desired products and/or services 12 available and provides a signal in response thereto. The system 10 also includes a second mechanism for employing a map displayed via the mobile computing device 16 to depict outlets with one or more of the one or more desired products and/or services 12 in response to the signal.

The first mechanism may be implemented in part via the GPS receiver system 22, which provides user-position information to the Internet-based inventory search system 30. The mobile computing device 16 runs software, such as the client software 26, which facilitates graphically coding each outlet and depicting each outlet on a moving map 20 of the mobile computing device 16 based on availability of the one or more desired products and/or services at each outlet. The client software 26 may employ color coding as the graphical-coding scheme.

The merchant inventory-tracking systems 46-56 may collect shelving information, such as GPS coordinates associated with the location of each product within a particular outlet. This shelving information may be employed by the inventory-search system 30 to facilitate implementing a mechanism for facilitating pinpointing within an outlet, such as the outlet 56, the one or more desired products and/or services 12 are located.

The merchant inventory-tracking systems 46-56 may maintain one or more store maps that depict where in the associated stores/outlets products and/or services, such as the desired products and/or available services 12, are located. The inventory-search system 30 may selectively retrieve such maps in response to user requests generated via the client software 26 running on the client computer 18 of the mobile computing device 16. The mobile computing device 16 may then download the maps to the computer 18. The client software 26 may then highlight or otherwise indicate one or more locations on each downloaded map where the desired products and/or services 12 are located. The resulting highlighted may then be displayed to the user 14 via the user interface 20 to enable to user 14 to easily locate the desired products and/or services within a particular store/outlet, such as the outlet 56 of FIG. 1.

The systems and methods 10, 70, 100, 130 of FIGS. 1-4 provide further synergistic effects and benefits when combined with a delivery system, such as one implemented according to U.S. Pat. No. 6,862,572, which is herein incorporated by reference. The combined systems implement a GPS-based delivery system or product/service-acquisition system that includes a computer system, such as the system 30 of FIGS. 1 and 4. In the combined embodiment, the computer system, i.e., inventory-search system 30, implements additional software and/or hardware modules or routines required to implement an embodiment of U.S. Pat. No. 6,862,572. A first mechanism 16 provides GPS coordinates associated with user 14 and a product/service query to the computer system 30. The GPS-based delivery system further includes software or hardware 36 running on the computer system 30 adapted to employ the GPS coordinates to perform a product/service availability-search of outlets 56, 58 within a predetermined range of the user 14 and providing search results in response thereto. The GPS-based delivery system further incorporates the embodiment of U.S. Pat. No. 6,862,572 to employ the search results to select a delivery mechanism for providing the product/service 12 to the user. Note that such a combined system enables GPS-based delivery to a moving delivery point. Hence, the user 14 of the mobile computing device 16 may have a product/service delivered while moving, since the location information employed by the delivery mechanism constructed according to U.S. Pat. No. 6,862,572 and incorporated in the module 30, may deliver to a destination based on GPS information, which may dynamically change with the user's location. As the user 14 changes position, relevant delivery destination information is updated by the computer system 30, which receives the updated information from the mobile computing device 16 via the GPS receiver system 22. The computer system 30 forwards this updated GPS location information to an initially selected delivery agent.

While the present embodiment is discussed with reference to efficiency systems and mobile-computing applications for facilitating acquisition of a desired product and/or service and/or for optimizing a travel route based on predetermined priorities, embodiments of the present invention are not limited thereto. For example, many types of applications, either wired or wireless may benefit from travel and product-acquisition efficiencies afforded by embodiments of the present invention. Employing novel methods and efficiency systems disclosed herein, such as those employing predictive routing, may yield improvements in virtually any physically distributed application, such as those requiring movement of people, products, or other articles between locations.

Variations and embodiments other than those discussed herein are possible. For example, embodiments employing networks other than the Internet or other packet switched networks; embodiments employing video calls; file transfers; conference calls, and so on are possible.

Although embodiments of the invention are discussed primarily with respect to server-client architecture, any acceptable architecture, topology, protocols, or other network and digital processing features can be employed. In general, network controllers, managers, access points, clients, and so on, can be implemented via any device with processing ability or other requisite functionality. It is also possible that functionality relevant to embodiments of the present invention can be included in a router, switch or device.

Although processes of the present invention and the hardware executing the processes may be characterized by language common to a discussion of the Internet (e.g., “client,” “server,” “peer”), it should be apparent that operations of the present invention can execute on any type of suitable hardware in any communication relationship to another device on any type of link or network.

Although a process of the present invention may be presented as a single entity, such as software executing on a single machine, such software can readily be executed on multiple machines. That is, there may be multiple instances of a given software program, a single program may be executing on two or more processors in a distributed processing environment, parts of a single program may be executing on different physical machines, etc. Furthermore, two different programs, such as a client and server program, can be executing in a single machine, or in different machines. A single program can be operating as a client for one information transaction and as a server for a different information transaction.

Any type of processing device can be used as a client. For example, portable computing devices, such as a personal digital assistant (PDA), cell phone, laptop computer, or other devices, can be employed. In general, the devices and manner of specific processing (including location and timing) are not critical to practicing important features of the present invention.

Although the invention has been discussed with respect to specific embodiments thereof, these embodiments are merely illustrative, and not restrictive, of the invention. Embodiments of the present invention can operate between any two processes or entities including users, devices, functional systems or combinations of hardware and software. Peer-to-peer networks and any other networks or systems where the roles of client and server are switched, change dynamically, or are not even present are within the scope of the invention.

Any suitable programming language can be used to implement the routines or other instructions employed by various network entities. Exemplary programming languages include C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations (see FIG. 3) described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “machine-readable medium” or “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented in whole or in part by using a programmed general purpose digital computer; by using application-specific integrated circuits, programmable logic devices, field programmable gate arrays, optical, chemical, biological, quantum or nanoengineered systems or mechanisms; and so on. In general, the functions of the present invention can be achieved by any means as is known in the art. Distributed or networked systems, components, and/or circuits can be used. Communication or data transfer may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”, “an”, and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the present invention has been described herein with reference to a particular embodiment for a particular application. Those having ordinary skill in the art and access to the present teachings will recognize additional modifications, applications, and embodiments within the scope thereof

It is therefore intended by the appended claims to cover any and all such applications, modifications and embodiments within the scope of the present invention.

Accordingly,

What is claimed is:

1. A system for facilitating acquisition of one or more desired products and/or services by a user comprising:
first means for providing a query containing information pertaining to said one or more desired products and/or services and
second means for performing an inventory search of multiple businesses or business locations based on said query and providing search results to said first means in response thereto, said search results containing Global Positioning System (GPS) coordinate information pertaining to said one or more desired products and/or services.

2. The system of claim 1 wherein said search results contain approximately real-time inventory and location information associated with said query, and wherein said multiple businesses include multiple independent businesses.

3. The system of claim 2 wherein said query includes price-preference information pertaining to one or more desired prices or price ranges associated with said one or more desired products and/or services.

4. The system of claim 3 wherein said search results include reported price information associated with said one or more desired products and/or services, said price-preference information affecting said search results.

5. The system of claim 4 further including means for employing said reported price information, said inventory information, and said GPS location information in combination with position information associated with a position of a user of said system, to selectively alert a user of said system when said user is within a predetermined range of one or more of said one or more products and/or services that are associated with prices that are consistent with said price-preference information.

6. The system of claim 1 wherein said system further includes third means for determining a preferred route between said user and said desired product or service based on said GPS location information and said inventory information.

7. The system of claim 6 wherein said third means further includes a GPS module in communication with said first means, said GPS module providing user location information to said third means.

8. The system of claim 7 wherein said second means includes an inventory-search system accessible by a computer via the Internet and/or said other network, said inventory-search system having access to one or more inventory-tracking systems of said multiple businesses.

9. The system of claim 1 wherein said GPS location information includes specific location information sufficiently detailed to indicate a region within a particular outlet wherein said desired product(s) and/or service(s) will be available.

10. The system of claim 9 further including fourth means for alerting said user when said user is within a predetermined region of a business outlet having said desired product(s) or service(s) available.

11. The system of claim 10 further including fifth means for incorporating a shopping list or task list within said query and activating said fourth means when said user is within a predetermined location of one or more business outlets having said product(s) and/or service(s) of said shopping list or task list available.

12. The system of claim 11 wherein said third means for determining an optimal route includes means for computing a route between plural outlets having said one or more products and/or services available.

13. The system of claim 12 wherein said route is further determined by said third means based on traffic information, said traffic information including traffic speeds and/or light signal patterns.

14. The system of claim 11 wherein said third means further includes sixth means for estimating an optimal speed for said user to travel en route to said desired product(s) and/or service(s) based on en route traffic information and/or traffic-light patterns.

15. The system of claim 14 further including one or more mobile sensors for providing said traffic information.

16. The system of claim 14 further including a traffic-light controller that manages traffic-light operation, said traffic-light controller providing traffic-light pattern information accessible by said computer for use by said sixth means.

17. The system of claim 6 wherein said third means includes means for predicting traffic flow at predetermined future times arrival times at predetermined positions along a route between a current location of said user and a projected location of said user and providing traffic flow predictions in response thereto, said third means further including means for determining said preferred route based on said traffic flow predictions.

18. A system for facilitating acquisition of one or more desired products and/or services by a user comprising:
a position-determining module adapted to determine a first location of said user;
a processor adapted to execute one or more instructions to determine a second location corresponding to a location of one or more desired products or services;
a first module that monitors traffic information;
a second module that determines one or more proposed routes between said first location and said second location based on map information; and
a third module that employs said traffic information and said one or more proposed routes to select a preferred route between said first location and said second location.

19. The system of claim 18 further including first means for facilitating enabling users of said system to avoid accident-prone intersections, roads, and/or routes.

20. The system of claim 18 further including second means for employing a weighting function to weight selection priorities employed by said third module to facilitate selecting said preferred route.

21. The system of claim 20 wherein said selection priorities are quantified via one or more variables, including a safety variable (Ws), a road-condition variable (Wc), and/or a en route-time variable (Wt), and wherein said weighting function is defined according to the following equation:
W=aWs+bWt+cWc,
where a, b, and c, are user-adjustable coefficients, and W represents a value employed by said additional means to facilitate selecting said preferred route based on one or more values of W.

22. The system of claim 18 wherein said third module is adapted to implement one or more instructions for projecting estimated traffic information at predetermined times along each of said one or more proposed routes to facilitate determining a preferred route between said first location and said second location.

23. The system of claim 18 wherein said traffic information includes traffic-speed information and traffic-light pattern information.

24. The system of claim 18 wherein said traffic information includes information pertaining to emergency routes selected by emergency vehicles.

25. The system of claim 24 further including means for notifying a user when said user is within a predetermined range of an emergency vehicle employing said system.

26. A system for facilitating acquisition of one or more desired products and/or services by a user comprising:
first means for automatically generating and sending queries to one or more inventory-tracking systems, said one or more inventory-tracking systems including inventory-tracking systems associated with independently owned business entities;
second means for storing results of said queries;
third means for accepting and forwarding one or more user-configurable queries, wherein said one or more user-configurable queries include one or more requests for inventory information, said inventory information being associated with a predetermined geographic location or region and one or more desired products and/or services;
fourth means for selectively accessing said results in response to said one or more user-configurable queries and providing user-requested results in response thereto.
fifth means for generating an alarm when said mobile computer is within a predetermined range of said one or more desired products and/or services based on said predetermined geographic location or region and a location of said mobile computer.

27. The system of claim 26 wherein said results of said queries include GPS coordinate information, which includes detailed coordinate information pertaining to locations of specific products and/or services in a particular outlet, wherein said detailed coordinate information is sufficiently specific to facilitate enabling a user to locate said particular product and/or service within said particular outlet.

28. The system of claim 27 wherein said results of said queries include projected inventory information.

29. A system for facilitating acquisition of one or more desired products and/or services by a user comprising:
a first system adapted to collect inventory information associated with one or more outlets;
a device in communication with said first system;
a location module adapted to provide user-location information associated with said device to said device;
a user interface associated with said device, said user interface adapted to receive, from said user, descriptive information specifying one or more desired products and/or services;
one or more routines in communication with said device, wherein said one or more routines are adapted to employ said user-location information, said descriptive information, and said first system to generate a signal when said device is within a predetermined range of said one or more desired products and/or services; and
an indicator adapted to alert said user in response to said signal.

30. A system for facilitating acquisition of one or more desired products and/or services comprising:
a computing device;
first means for determining when a user of said computing device is within a predetermined range of said one or more desired products and/or services and providing a signal in response thereto; and
second means for employing a map displayed via said mobile computing device to depict one or more outlets having one or more of said one or more desired products and/or services available in response to said signal.

31. A system for facilitating acquisition of one or more desired products and/or services by a user comprising:
a computer system;
first means for providing GPS coordinates associated with a user and a product/service query to said computer system;
software or hardware running on said computer system adapted to employ said GPS coordinates to perform a product/service availability-search of outlets within a predetermined range of said user and providing search results in response thereto; and
second means for employing said search results to select a delivery mechanism for providing said product/service to said user.

32. The system of claim 31 wherein said computer system is constructed in accordance with U.S. Pat. No. 6,862,572.
